(19) United States
(12) Patent Application Publication
(10) Pub. No.: US 2024/0078951 A1
(43) Pub. Date: Mar. 7, 2024

(54) MANUFACTURING METHOD OF MULTI-SCREEN DISPLAY

(71) Applicant: CARUX TECHNOLOGY PTE. LTD., SINGAPORE (SG)

(72) Inventors: Shun-Chen YANG, Tainan (Tainan Science Park) (TW); Yu-Lun HSU, Tainan (Tainan Science Park) (TW)

(21) Appl. No.: 18/366,926

(22) Filed: Aug. 8, 2023

(30) Foreign Application Priority Data
Sep. 5, 2022 (CN) 202211095187.9

(51) Int. Cl. G09G 3/20

(52) U.S. Cl. CPC G09G 3/2003; G09G 2300/026; G09G 2320/0666; G09G 2320/0693

(57) ABSTRACT

A manufacturing method of a multi-screen display is provided. The manufacturing method includes the following steps. A first panel is provided. A second panel is provided. The first panel and the second panel are spliced. The first color coordinate of the first panel includes a first horizontal coordinate and a first vertical coordinate, and the second color coordinate of the second panel includes a second horizontal coordinate and a second vertical coordinate. The difference between the horizontal coordinate and the second horizontal coordinate is Δx, the difference between the first vertical coordinate and the second vertical coordinate is Δy, and Δx and Δy satisfy the following relationship: θ=arctan(Δx/Δy), 46 degrees≤θ≤126 degrees.

### CROSS REFERENCE TO RELATED APPLICATIONS

This application claims priority of China Patent Application No. 202211095187.9, filed on Sep. 5, 2022, the entirety of which is incorporated by reference herein.

### BACKGROUND OF THE INVENTION

### Field of the Invention

The present invention relates to a manufacturing method of an electronic device, and, in particular, to a manufacturing method of a multi-screen display.

### Description of the Related Art

In recent years, multi-screen displays have been widely used in various fields. The multi-screen display is assembled by splicing multiple screens (panels). However, the colors of the different screens are usually different, which affects the display quality.

Therefore, developing a manufacturing method improves the consistency of optical quality of multi-screen displays is one of the current research topics in the industry.

### BRIEF SUMMARY OF THE INVENTION

According to some embodiments of the present disclosure, a manufacturing method of a multi-screen display is provided. The manufacturing method includes the following steps. A first panel is provided. A second panel is provided. The first panel and the second panel are spliced. The first color coordinate of the first panel includes a first horizontal coordinate and a first vertical coordinate, and the second color coordinate of the second panel includes a second horizontal coordinate and a second vertical coordinate. The difference between the horizontal coordinate and the second horizontal coordinate is Δx, the difference between the first vertical coordinate and the second vertical coordinate is Δy, and Δx and Δy satisfy the following relationship: θ=arctan(Δx/Δy), 46 degrees≤θ≤126 degrees.

In order to make the features or advantages of the present disclosure more comprehensible, some embodiments are illustrated hereinafter, and detailed descriptions are provided with reference to the drawings.

### BRIEF DESCRIPTION OF THE DRAWINGS

FIG. 1 shows the flowchart of the steps of the manufacturing method of the multi-screen display according to some embodiments of the present disclosure.

FIG. 2 shows the measured results of the first color coordinate group of the first batch of panels and the second color coordinate group of the second batch of panels according to some embodiments of the present disclosure.

FIG. 3 shows the color coordinate relation diagram between the first color coordinate of the first panel and the second color coordinate of the second panel, and the color coordinate relation diagram between the third color coordinate and the fourth color coordinate according to some embodiments of the present disclosure.

### DETAILED DESCRIPTION OF THE INVENTION

Hereinafter is a detailed description of the multi-screen display of the embodiments of the present disclosure. It should be understood that the following description provides many different embodiments for implementing various aspects of some embodiments of the present disclosure. The specific elements and arrangements described below are merely to clearly describe some embodiments of the present disclosure. Of course, these are only used as examples rather than limitations of the present disclosure. Furthermore, similar and/or corresponding reference numerals may be used in different embodiments to designate similar and/or corresponding elements, in order to clearly describe the present disclosure. However, the use of these similar and/or corresponding reference numerals is only for the purpose of simply and clearly description of some embodiments of the present disclosure, and does not imply any correlation between the different embodiments and/or structures discussed.

The embodiments of the present disclosure can be understood together with the drawings, and the drawings of the present disclosure are also regarded as a part of the disclosure description. It should be understood that the drawings of the present disclosure are not drawn to scale, and in fact, the dimensions of elements may be arbitrarily enlarged or reduced in order to clearly represent the features of the present disclosure.

In addition, it should be understood that the ordinal numbers such as “first”, “second”, and the like used in the specification and claims are used to modify elements and are not intended to imply and represent the element(s) have any previous ordinal numbers, and do not represent the order of a certain element and another element, or the order of the manufacturing method. The use of these ordinal numbers is only used to clearly distinguish an element with a certain name and another element with the same name. The claims and the specification may not use the same terms, for example, a first element in the specification may be a second element in the claims.

In some embodiments of the present disclosure, the terms such as “connect” and “interconnect” about bonding and connecting, unless otherwise specified, may mean that two structures are in direct contact, or may also mean that two structures are not in direct contact, wherein other structures are disposed between the two structures. Moreover, the terms about bonding and connecting may also include the situation that both structures are movable, or both structures are fixed. In addition, the terms “electrically connected” or “coupled” include any direct and indirect means of electrical connection.

The terms “about”, “substantially”, and “approximately” used herein generally mean within 10%, within 5%, within 3%, within 2%, within 1%, or within 0.5% of a given value or a given range. The phrase “a range is between a first value and a second value” means that the range includes the first value, the second value, and other values in between.

It should be understood that the following embodiments can be replaced, reorganized, and combined to complete other embodiments without departing from the spirit of the present disclosure. The features of the various embodiments can be used in any combination and collocation, as long as they do not violate the spirit of the invention or conflict.

Unless otherwise defined, all terms including technical and scientific terms used herein have the same meaning as commonly understood by a person of ordinary skills in the art. It should be understood that these terms, such as those defined in commonly used dictionaries, should be interpreted as having meanings consistent with the relevant art and the background or context of the present disclosure, and should not be interpreted in an idealized or overly formal manner, unless otherwise defined in the embodiments of the present disclosure.

According to the embodiments of the present disclosure, a manufacturing method of a multi-screen display is provided. Through the steps of measuring and sorting the color coordinates, the color coordinates of the different screens (panels) such as standard screens and matching screens satisfy a specific relationship. Therefore, the colors of different screens can be matched, and the consistency of the optical quality of the screens can be improved, while the loss of the panels' transmittance is reduced, so as to improve the overall display quality of the multi-screen display.

According to the embodiments of the present disclosure, the multi-screen display (also referred to as a display splicing-device) may be a bendable or flexible display device, and the display device may be a display splicing-device, but the present disclosure is not limited thereto. The display device may be a non-self-luminous display device or a self-luminous display device. Furthermore, the display device may, for example, include liquid-crystal, quantum dot (QD), fluorescence, phosphor, other suitable materials, or combinations thereof. The display device may include electronic elements, and the electronic elements may include passive elements and active elements, such as capacitors, resistors, inductors, diodes, transistors, and the like. The diodes may include light-emitting diodes or photodiodes. The light-emitting diodes may, for example, include organic light-emitting diodes (OLEDs), mini light-emitting diodes (mini LEDs), micro light-emitting diodes (micro LEDs), or quantum dot light-emitting diodes (quantum dot LEDs), but the present disclosure is not limited thereto. The display device may include a panel, a backlight module, or both. According to some embodiments, in addition to the panel, the display device may also have peripheral systems such as a driving system, a control system, a light source system, or a shelf system to support the panel.

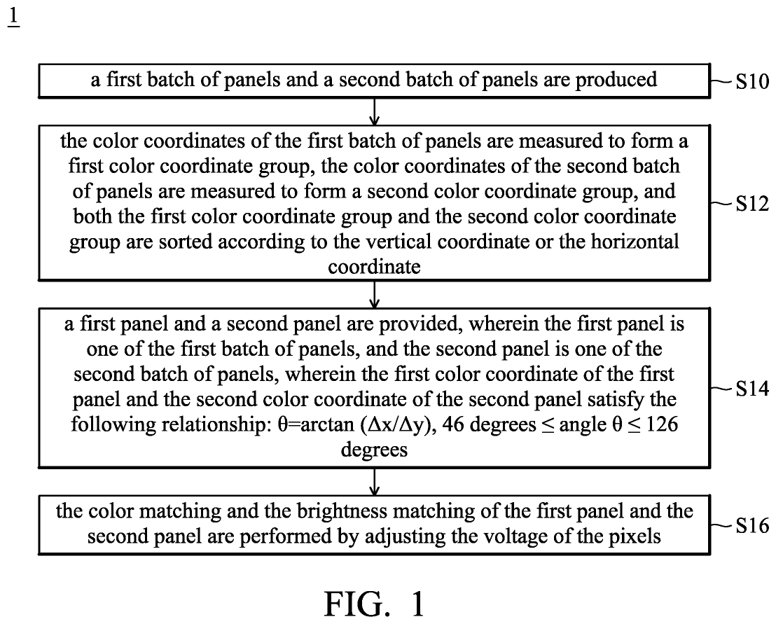

Referring to FIG. 1, FIG. 1 shows a flowchart of steps of a manufacturing method of a multi-screen display according to some embodiments of the present disclosure. It should be understood that, according to some embodiments, additional steps may be added before, during and/or after the manufacturing method 1 of the multi-screen display, or some steps may be replaced or omitted.

According to some embodiments, the manufacturing method 1 of the multi-screen display may include producing a first batch of panels and a second batch of panels (step S10).

According to some embodiments, both the first batch of panels and the second batch of panels may include a plurality of panels produced in the same batch, but the present disclosure is not limited thereto. Furthermore, the panels in this step may be in the state after the driving substrate is assembled with the color-filter substrate, but the present disclosure is not limited thereto. For example, in some embodiments, the panels may be in the state after the protective film is set above the driving substrate. According to some embodiments, the mentioned panel may include a liquid-crystal panel or other self-luminous panels, but the present disclosure is not limited thereto.

Specifically, the driving substrate of the panel may include a substrate and a driving circuit disposed thereon, and the driving circuit may include an active driving circuit, a passive driving circuit, or both. According to some embodiments, the driving circuit may include thin-film transistors (TFTs) (for example, switching transistors, driving transistors, reset transistors, or other thin-film transistors), data lines, scanning lines, touch signal lines, conductive pads, dielectric layers, capacitors, or other lines, etc., but the present disclosure is not limited thereto. In addition, the thin-film transistor may be a top gate thin-film transistor, a bottom gate thin-film transistor, or a dual gate (or double gate) thin-film transistor. The thin film transistor includes at least one semiconductor layer, and the semiconductor layer includes but not limited to amorphous silicon, low-temp polysilicon (LTPS), metal oxide, other suitable materials, or combinations thereof, but the present disclosure is not limited thereto. The metal oxide may include indium gallium zinc oxide (IGZO), indium zinc oxide (IZO), indium gallium zinc tin oxide (IGZTO), and other suitable materials, or combinations thereof, but the present disclosure is not limited thereto. Furthermore, the color-filter substrate may include a substrate and a color-filter layer or a light-shielding layer disposed thereon, but the present disclosure is not limited thereto.

According to some embodiments, the manufacturing method 1 of the multi-screen display may include the following steps. The color coordinates of the first batch of panels are measured to form the first color coordinate group, the color coordinates of the second batch of panels are measured to form the second color coordinate group, and both the first color coordinate group and the second color coordinate group are sorted according to the vertical coordinate (Y coordinate) or the horizontal coordinate (X coordinate) (step S12). When measuring the color coordinates, a first signal is first transmitted to the first batch of panels, and the color coordinates of images generated by the first batch of panels according to the first signal are measured to obtain the first color coordinate group. Then, the first signal is transmitted to the second batch of panels, and the second color coordinate group is obtained after the color coordinates of the images generated by the second batch of panels according to the first signal are measured.

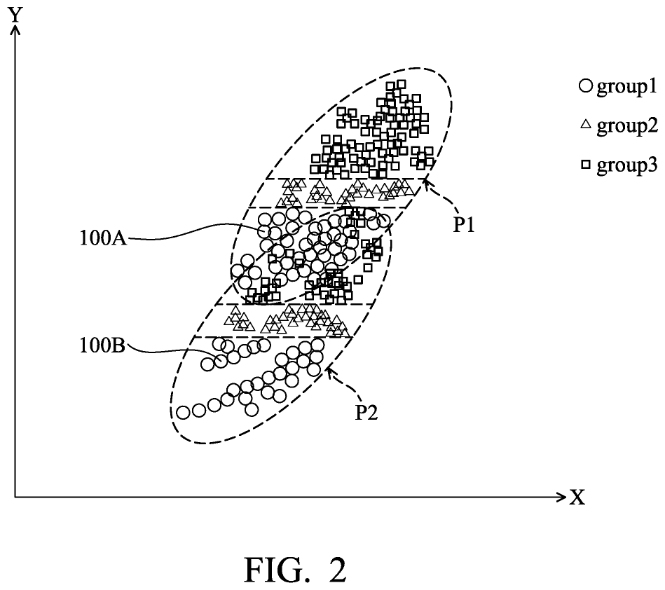

For details, referring to FIG. 2, FIG. 2 shows the measured results of the first color coordinate group of the first batch of panels and the second color coordinate group of the second batch of panels according to some embodiments of the present disclosure. As shown in FIG. 2, the color coordinates of multiple panels of the first batch of panels may be measured to obtain the first color coordinate group P1, and the color coordinates of multiple panels of the second batch of panels may be measured to obtain the second color coordinates group P2, wherein each color coordinate corresponds to a measurement result of one panel. According to some embodiments, the first color coordinate group P1 and the second color coordinate group P2 may be sorted into A groups according to the vertical coordinate (Y coordinate), wherein A is a natural number. For example, the first color coordinate group P1 and the second color coordinate group P2 may be sorted into 3 groups (group 1, group 2, and group 3) as shown in FIG. 2. That is, the first batch of panels and the second batch of panels are sorted into 3 groups, but the present disclosure is not limited thereto. Alternatively, according to some embodiments, the first color coordinate group P1 and the second color coordinate group P2 may be sorted into M groups according to the horizontal coordinate (X coordinate), wherein M is a natural number. It should be noted that, in some embodiments, the first batch of panels and the second batch of panels may be sorted by using the normal distribution curve. For example, when sorting the first batch of panels according to the vertical coordinate, the standard deviation (hereinafter referred to as the vertical standard deviation) between the vertical coordinate of the average color coordinate of the first color coordinate group P1 (hereinafter referred to as the vertical mean value) and the vertical coordinate may be calculated, and the first color coordinate group P1 is then sorted into 3 groups according to “greater than the vertical mean value+m times of the vertical standard deviation”, “between the vertical mean value+m times of the vertical standard deviation and the vertical mean value−m times of the vertical standard deviation”, and “less than the vertical mean value−m times of the vertical standard deviation”. The value of m herein may be between 1 and 2 (for example, m=1.7), but the way of sorting and the range of the value of m in the present disclosure are not limited thereto. For example, in some embodiments, the first batch of panels may also be sorted according to the horizontal coordinate in a manner similar to the mentioned method after calculating the standard deviation between the horizontal coordinate of the average color coordinate of the first color coordinate group P1 and the horizontal coordinates.

It should be understood that the numbers of groups after sorting the first color coordinate group P1 and the second color coordinate group P2 are not limited to those shown in the figure. According to different embodiments, the color coordinate groups may be sorted into groups with appropriate numbers according to the required product specifications. The number of groups is, for example, 2, 3, 4, 5, or 6, etc., but the present disclosure is not limited thereto. According to some embodiments, the groups may be sorted according to the colors corresponding to the color coordinates. For example, those colors which are bluish in the color coordinate group are sorted into one group, those colors which are reddish in the color coordinate group are sorted into one group, and those colors which are more yellowish in the color coordinate group are sorted into one group, but the present disclosure is not limited thereto.

In addition, a spectrum analyzer, a spectroscope, a luxometer, or other suitable instruments may be used to measure the panels to obtain the color coordinates. According to an embodiment of the present disclosure, the color coordinates are those defined by the CIE1931 color space, but the present disclosure is not limited thereto.

Furthermore, the manufacturing method 1 of the multi-screen display may include providing a first panel and a second panel, wherein the first panel is one of the first batch of panels, and the second panel is one of the second batch of panels (step S14).

Referring to FIG. 2, more specifically, the corresponding first and second panels may be selected from the same groups (group 1, group 2, and group 3) of the first color coordinate group P1 and the second color coordinate group P2. For example, the first panel may be the panel 100A corresponding to the first color coordinate in group 1 of the first color coordinate group P1, and the second panel may be the panel 100B corresponding to the second color coordinate in group 1 of the second color coordinate group P2. According to some embodiments, the first panel 100A and the second panel 100B may be two adjacent panels in the multi-screen display. That is, the first panel 100A and the second panel 100B may be spliced together.

It should be noted that since the first panel 100A and the second panel 100B correspond to the color coordinates in the same group of the first color coordinate group P1 and the second color coordinate group P2 (for example, the first color coordinate of the first panel 100A is in the group 1 of the first color coordinate group P1, and the color coordinate of the second panel 100B is also in the group 1 of the second color coordinate group P2), so the difference between the color coordinates of the selected first panel 100A and second panel 100B is small (for example, the difference is much smaller than the case where the first panel 100A is selected from group 3 of the first color coordinate group P1 while the second panel 100B is selected from group 1 of the second color coordinate group P2). It helps to improve the consistency of the optical quality of the screen.

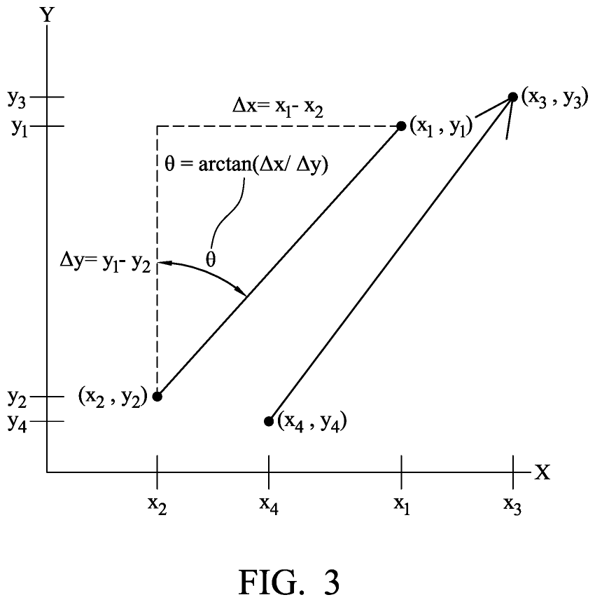

In detail, referring to FIG. 3, FIG. 3 shows a color coordinate relation diagram between the first color coordinate of the first panel 100A and the second color coordinate of the second panel 100B according to some embodiments of the present disclosure. As shown in FIG. 3, in the process of selecting the first panel 100A and the second panel 100B, the first color coordinate of the first panel 100A includes a first horizontal coordinate x₁ and a first vertical coordinate y₁ (i.e., (x₁,y₁)), and the second color coordinate of the second panel 100B includes a second horizontal coordinate x₂ and a second vertical coordinate y₂ (i.e., (x₂,y₂)). The difference between the first horizontal coordinate x₁ and the second horizontal coordinate x₂ is Δx(=x₁−x₂), the difference between the first vertical coordinate y₁ and the second vertical coordinate y₂ is Δy(=y₁−y₂), and Δx and Δy satisfy the following relationship: θ=arctan (Δx/Δy), 46 degrees≤angle θ≤126 degrees.

The difference Δx between the first horizontal coordinate x₁ and the second horizontal coordinate x₂ may be positive or negative, and the difference Δy between the first vertical coordinate y₁ and the second vertical coordinate y₂ may also be positive or negative. Moreover, the angle θ is defined as the included angle between a connecting line and an included line, wherein the connecting line is a line from the second color coordinate (x₂, y₂) of the second panel 100B to the first color coordinate (x₁, y₁) of the first panel 100A, and the extension line passes through the second color coordinate (x₂, y₂) of the second panel 100B and is parallel to the Y-axis.

As mentioned above, according to some embodiments, the first color coordinate group P1 and the second color coordinate group P2 may be sorted into A groups according to the vertical coordinate (Y coordinate), wherein A is a natural number, while the color coordinate (x₁, y₁) of the first panel 100A is in the group B of the first color coordinate group P1, and the second color coordinate (x₂, y₂) of the second panel 100B is also in the group B of the second color coordinate group P2, wherein A and B are natural numbers, and B≤A. Specifically, taking the embodiment mentioned in FIG. 2 as an example, the first color coordinate group P1 and the second color coordinate group P2 may be sorted into 3 groups according to the mentioned sorting method (A=3, group 1, group 2, and group 3), wherein the first color coordinate (x₁, y₁) of the first panel 100A is in the first group (B=1, group 1) of the first color coordinate group P1, and the second color coordinate (x₂, y₂) of the second panel 100B is also in the first group (B=1, group 1) of the second color coordinate group.

As mentioned above, according to some embodiments, the first color coordinate group P1 and the second color coordinate group P2 may also be sorted into M groups according to the horizontal coordinate (X coordinate), wherein M is a natural number, while the first color coordinate (x₁, y₁) of the first panel 100A is in the group N of the first color coordinate group P1, and the second color coordinate (x₂, y₂) of the second panel 100B is also in the group N of the second color coordinate group P2, wherein M and N are natural numbers, and N≤M.

According to some embodiments, the absolute value of the difference between the first vertical coordinate y₁ of the first color coordinate (x₁, y₁) and the second vertical coordinate y₂ of the second color coordinate (x₂, y₂) is less than or equal to 0.04 (that is, |(y1−y2)|≤0.04). According to some embodiments, the absolute value of the difference between the first horizontal coordinate x₁ of the first color coordinate (x₁, y₁) and the second horizontal coordinate x₂ of the second color coordinate (x₂, y₂) is less than or equal to 0.04 (that is, |(x₁−x₂)|≤0.04). It should be noted that when the absolute value of the difference between the first vertical coordinate y₁ and the second vertical coordinate y₂ is less than or equal to 0.04, and when the absolute value of the difference between the first horizontal coordinate x₁ and the second horizontal coordinate x₂ is less than or equal to 0.04, the optical properties (such as color) of the first panel 100A and the second panel 100B are quite similar, which may effectively reduce the difference in optical characteristics between the adjacent first panel 100A and the second panel 100B.

In the manufacturing method 1 of the multi-screen display, after providing the first panel 100A and the second panel 100B, a step of performing color matching of the first panel 100A and the second panel 100B by adjusting the voltage of the pixels may be included (step S16 in FIG. 1). For example, when the first panel 100A is used as a reference, the voltage of the pixels in the second panel 100B is adjusted to perform color matching. Specifically, when the first color coordinate (x₁, y₁) of the first panel 100A and the second color coordinate (x₂, y₂) of the second panel 100B selected in the mentioned step S14 satisfy the mentioned relationship: θ=arctan(Δx/Δy) and 46 degrees≤angle θ≤126 degrees, the loss of light transmittance of the panel (such as the second panel 100B) in the process of color matching will be effectively reduced. Furthermore, since the loss of light transmittance of the panel is greatly reduced, the overall power consumption of the multi-screen display may be reduced.

Still referring to FIG. 3, similar to the way of measuring the color coordinates during producing the first panel 100A and the second panel 100B, according to some embodiments, the way of the color matching of the first panel 100A and the second panel 100B may include the following step. When measuring the third color coordinate (x₃,y₃) of the first panel 100A and the fourth color coordinate (x₄, y₄) of the second panel 100B, the second signal may be first transmitted to the first panel 100A, so that the third color coordinate (x₃,y₃) of the image generated by the first panel 100A according to second signal corresponds to a standard color, and then the second signal is transmitted to the second panel 100B. Then the fourth color coordinate (x₄, y₄) of the image generated by the second panel 100B according to the second signal is measured. At this time the coordinate of the third color (x₃,y₃) should be different from the coordinate of the fourth color coordinate (x₄,y₄), and since the first signal may be different from the second signal, the third color (x₃,y₃) may be different from the first color coordinate (x₁,y₁). In addition, when matching the colors of the first panel 100A and the second panel 100B, a third signal may be further provided, so that the fifth color coordinate of the image generated by the second panel 100B according to the third signal corresponds to the standard color, and the third signal is different from the second signal, thereby changing the color output from the second panel 100B.

According to some embodiments, the first panel 100A may be used as a standard screen, and the second panel 100B may be a matching screen matched with the standard screen. According to some embodiments, when performing color matching, the standard color corresponding to the first panel 100A may be a standard white. For example, in the CIE1931 color space, the color coordinate of the standard white is (0.33, 0.33). According to some embodiments, the second signal may include a second red signal, a second green signal, or a second blue signal, and the third signal may include a third red signal, a third green signal, or a third blue signal, wherein the second blue signal is different from the third blue signal, but the present disclosure is not limited thereto. In some embodiments, the second red signal may be different from the third red signal, or the second green signal may be different from the third green signal. In other words, according to some embodiments, both the second signal and the third signal may provide a red sub-pixel signal, a green sub-pixel signal, or a blue sub-pixel signal to the first panel 100A and the second panel 100B to further control the voltage of the red sub-pixel, the green sub-pixel, or the blue sub-pixel of the first panel 100A and the second panel 100B.

Specifically, taking the embodiment of FIG. 3 as an example, the first panel 100A may be used as a standard screen, and the second panel 100B may be used as a matching screen. The second signal (for example, at least one of the red, green, and blue signals) may be input to the first panel 100A first, so that the third color coordinate (x₃,y₃) of the first panel 100A corresponds to the standard color, and then the mentioned second signal is transmitted to the second panel 100B and the fourth color coordinates (x₄,y₄) of the second panel 100B is measured. Next, a third signal different from the second signal (for example, at least one of red, green, and blue signals) may be provided to the second panel 100B, so that the fifth color coordinate of the second panel 100B corresponds to a standard color, therefore the color output of the second panel 100B may be adjusted to be the same as or similar to that of the first panel 100A. In other words, the fifth color coordinate of the second panel 100B may be adjusted to be the same as the third color coordinate (x₃,y₃) of the first panel 100A.

According to some embodiments, the first panel 100A and the second panel 100B may be placed together onto a backlight module (not shown) to perform the mentioned color matching step.

According to some embodiments of the present disclosure, a multi-screen display manufactured by the mentioned method is provided, which may include a first panel and a second panel adjacent to each other or even spliced together. When a signal is provided to the first panel and another signal is provided to the second panel, the signal provided to the first panel is different from the signal provided to the second panel, but the color coordinates of the first panel and the second panel are approximately the same. In other words, providing different signals to the first panel and the second panel may cause the first panel and the second panel to have substantially the same color coordinates, thus enabling the first panel and the second panel to have similar optical performance (e.g., color) or have the consistent display quality.

Specifically, according to some embodiments, when the same signal is provided to the first panel and the second panel, the absolute value of the difference between the vertical coordinate of the color coordinate of the first panel and the vertical coordinate of the color coordinate of the second panel is less than or equal to 0.04 (that is, |Δy(=y₁−y₂)|≤0.04). According to some embodiments, the absolute value of the difference between the horizontal coordinate of the color coordinate of the first panel and the horizontal coordinate of the color coordinate of the second panel is less than or equal to 0.04 (that is, |Δx(=x₁−x₂)|≤0.04).

According to some embodiments, the first panel 100A may be used as a standard screen, and the second panel 100B may be a matching screen matched with the standard screen. When performing the color matching, the color coordinate corresponding to the first panel 100A roughly corresponds to the standard white color coordinate (0.33, 0.33).

It should be understood that the number of panels of the multi-screen display is not limited to two (the first panel and the second panel). According to different embodiments, any suitable number of panels may be manufactured by the mentioned method, and the multiple panels may be adjusted to have similar optical performances through the mentioned steps.

In summary, according to the embodiments of the present disclosure, a manufacturing method of a multi-screen display is provided. Through the steps of measuring and sorting the color coordinates, the color coordinates of the different screens (panels) such as standard screens and matching screens satisfy a specific relationship. Therefore, the colors of different screens can be matched, and the consistency of the optical quality of the screens can be improved, while the loss of the panels' transmittance is reduced, so as to improve the overall display quality of the multi-screen display.

Although the embodiments of the present disclosure and their advantages have been disclosed above, it should be understood that a person of ordinary skill in the art may make combinations, changes, replacing, and retouching without departing from the spirit and scope of the present disclosure. The features of the disclosed embodiments can be mixed and matched arbitrarily as long as they do not violate the spirit of the invention or conflict with each other. In addition, the foregoing outlines features of several embodiments of the present disclosure, so that a person of ordinary skill in the art may better understand the aspects of the present disclosure. A person of ordinary skill in the art should appreciate that, the present disclosure may be readily used as a basis for designing or modifying other processes and structures for carrying out the same purposes and/or achieving the same advantages of the embodiments introduced herein. A person of ordinary skill in the art should also realize that such equivalent constructions do not depart from the spirit and scope of the present disclosure, and that they may make various changes, substitutions, and alterations herein without departing from the spirit and scope of the present disclosure.

What is claimed is:

1. A manufacturing method of a multi-screen display, comprising:
providing a first panel;
providing a second panel; and
splicing the first panel and the second panel,
wherein a first color coordinate of the first panel comprises a first horizontal coordinate and a first vertical coordinate, and a second color coordinate of the second panel comprises a second horizontal coordinate and a second vertical coordinate, wherein a difference between the horizontal coordinate and the second horizontal coordinate is Δx, a difference between the first vertical coordinate and the second vertical coordinate is Δy, and Δx and Δy satisfy the following relationship: θ=arctan(Δx/Δy), 46 degrees≤θ≤126 degrees.

2. The manufacturing method of the multi-screen display claimed in claim 1, wherein an absolute value of the difference between the first vertical coordinate of the first color coordinate and the second vertical coordinate of the second color coordinate is less than or equal to 0.04.

3. The manufacturing method of the multi-screen display claimed in claim 1, wherein an absolute value of the difference between the first horizontal coordinate of the first color coordinate and the second horizontal coordinate of the second color coordinate is less than or equal to 0.04.

4. The manufacturing method of the multi-screen display claimed in claim 1, further comprising:
producing a first batch of panels and a second batch of panels, wherein the first panel is one of the first batch of panels, and the second panel is one of the second batch of panels.

5. The manufacturing method of the multi-screen display claimed in claim 4, further comprising:
measuring color coordinates of the first batch of panels to form a first color coordinate group; and
measuring color coordinates of the second batch of panels to form a second color coordinate group, and sorting both the first color coordinate group and the second color coordinate group into A groups according to a vertical coordinate, wherein the first color coordinate of the first panel is in a group B of the first color coordinate group, and the second color coordinate of the second panel is in the group B of the second color coordinate group, wherein A and B are natural numbers, and B≤A.

6. The manufacturing method of the multi-screen display claimed in claim 5, wherein when forming the first color coordinate group and the second color coordinate group, a first signal is first transmitted to the first batch of panels and the first batch of panels are measured, and the first signal is then transmitted to the second batch of panels and the second batch of panels are measured.

7. The manufacturing method of the multi-screen display claimed in claim 4, further comprising:
measuring color coordinates of the first batch of panels to form a first color coordinate group; and
measuring color coordinates of the second batch of panels to form a second color coordinate group, and sorting both the first color coordinate group and the second color coordinate group into M groups according to a horizontal coordinate, wherein the first color coordinate of the first panel is in a group N of the first color coordinate group, and the second color coordinate of the second panel is in the group N of the second color coordinate group, wherein M and N are natural numbers, and N≤M.

8. The manufacturing method of the multi-screen display claimed in claim 1, further comprising performing a color matching of the first panel and the second panel.

9. The manufacturing method of the multi-screen display claimed in claim 8, wherein the color matching of the first panel and the second panel comprises transmitting a second signal to the first panel and the second panel, so that a third color coordinate of an image generated by the first panel according to the second signal corresponds to a standard white color, and a fourth color coordinate of an image generated by the second panel according to the second signal is different from the third color coordinate.

10. The manufacturing method of the multi-screen display claimed in claim 9, further comprising providing a third signal to the second panel, so that a fifth color coordinate generated by the second panel according to the third signal corresponds to the standard white color, and the third signal is different from the second signal.

11. The manufacturing method of the multi-screen display claimed in claim 10, wherein the second signal comprises a second red signal, a second green signal, or a second blue signal, and the third signal comprises a third red signal, a third green signal, or a third blue signal.

12. The manufacturing method of the multi-screen display claimed in claim 8, before performing the color matching of the first panel and the second panel, further comprising placing the first panel and the second panel onto a backlight module.

13. The manufacturing method of the multi-screen display claimed in claim 4, further comprising:
measuring color coordinates of the first batch of panels to form a first color coordinate group; and
measuring color coordinates of the second batch of panels to form a second color coordinate group, and sorting both the first color coordinate group and the second color coordinate group according to a normal distribution curve.

14. The manufacturing method of the multi-screen display claimed in claim 13, wherein sorting both the first color coordinate group and the second color coordinate group according to the normal distribution curve comprises:
calculating a standard deviation between a vertical coordinate of an average color coordinate of the first color coordinate group and the vertical coordinate, and sorting the first color coordinate group into 3 groups according to “greater than a vertical mean value+m times of a vertical standard deviation”, “between the vertical mean value+m times of the vertical standard deviation and the vertical mean value−m times of the vertical standard deviation”, and “less than the vertical mean value−m times of the vertical standard deviation”.

15. The manufacturing method of the multi-screen display claimed in claim 14, wherein a value of m is between 1 and 2.

16. The manufacturing method of the multi-screen display claimed in claim 13, wherein sorting both the first color coordinate group and the second color coordinate group according to the normal distribution curve comprises:
calculating a standard deviation between a horizontal coordinate of an average color coordinate of the first color coordinate group and the horizontal coordinate, and sorting the first color coordinate group into 3 groups according to “greater than a horizontal mean value+m times of a horizontal standard deviation”, “between the horizontal mean value+m times of the horizontal standard deviation and the horizontal mean value−m times of the horizontal standard deviation”, and “less than the horizontal mean value−m times of the horizontal standard deviation”.

17. The manufacturing method of the multi-screen display claimed in claim 16, wherein a value of m is between 1 and 2.

18. The manufacturing method of the multi-screen display claimed in claim 4, further comprising:
measuring color coordinates of the first batch of panels to form first color coordinate group; and
measuring color coordinates of the second batch of panels to form a second color coordinate group, and sorting both the first color coordinate group and the second color coordinate group according to color.

19. The manufacturing method of the multi-screen display claimed in claim 16, wherein the colors comprises blue, red, and yellow.

20. The manufacturing method of the multi-screen display claimed in claim 1, wherein the first color coordinate and the second color coordinate are defined by the CIE1931 color space.
